(19) United States
(12) Patent Application Publication
(10) Pub. No.: US 2019/0375580 A1
(43) Pub. Date: Dec. 12, 2019

(54) ELECTRONIC MUSICAL INSTRUMENT

(71) Applicant: Roland Corporation, Shizuoka (JP)

(72) Inventor: Kotaro Nomura, Hamamatsu, Shizuoka (JP)

(73) Assignee: Roland Corporation, Shizuoka (JP)

(21) Appl. No.: 16/489,350

(22) PCT Filed: Feb. 28, 2017
(86) PCT No.: PCT/JP2017/007885

§ 371 Date: Aug. 27, 2019

(51) Int. Cl. B65D 85/68; B65D 81/113; G10H 3/14; B65D 5/10

(52) U.S. Cl. CPC B65D 85/68; B65D 81/113; B65D 2203/00; B65D 5/10; B65D 2585/6897; G10H 3/14

(57) ABSTRACT

An electronic musical instrument that is easy to use is provided. The electronic musical instrument includes a packing box (2) formed into a box shape capable of accommodating a converter (4) and an output device (5). The packing box (2) has an opening portion (21a) formed in a side surface, and thus it is possible to use the packing box (2) as a percussion instrument simulating a Cajon taking the opening portion (21) a as a sound hole. That is, an electronic musical instrument (1) is used employing the packing box (2) that simulates a Cajon, and thus labor for preparing a musical instrument is saved. Thus, the electronic musical instrument (1) is easy to use.

### BACKGROUND OF THE INVENTION

### Technical Field

The present invention relates to an electronic musical instrument, in particular, to an electronic musical instrument that can improve versatility.

### Related Art

A technology is known that generates musical sound by mounting a contact microphone (converter) on a sound source (e.g., a sound hole of a musical instrument or a top head of a percussion instrument) to detect vibration and converting the vibration into an electrical signal. For example, an electronic musical instrument that is configured to be capable of fixing a contact microphone with respect to the musical instrument by a clip and generates musical sound on the basis of vibration detected through the contact microphone is disclosed in Patent Literature 1.

According to this electronic musical instrument, the contact microphone is mounted on the musical instrument (e.g., the sound hole of a guitar or a Cajon) or other sound sources (e.g., a magazine or a plate), thereby generating musical sound on the basis of vibration of the sound source. Accordingly, for example, when the contact microphone is mounted on a magazine, it is possible to generate musical sound of cymbals by beating the magazine.

### LITERATURE OF RELATED ART

### Patent Literature

Patent Literature 1: Japanese Laid-Open No. 2016-053604 (e.g., paragraphs 0027 and 0028, and FIG. 3)

### SUMMARY

### Problems to be Solved

However, in the related art described above, when an electronic musical instrument is used employing a musical instrument, it is required to prepare the musical instrument. Accordingly, there was a problem that it is troublesome to use an electronic musical instrument.

The present invention is accomplished to solve the problems described above and the objective is to provide an electronic musical instrument that can be easily used.

### Means to Solve Problems

In order to achieve the objective, an electronic musical instrument of the present invention includes a converter that is configured to be freely attached to/detached from a vibrator vibrated by playing of a player and that is used to convert vibration detected from the vibrator into an electrical signal, and an output device connected to the converter and used to output the electrical signal converted by the converter to the outside. Further, the electronic musical instrument includes a packing box formed into a box shape capable of accommodating the converter and the output device, and the packing box has an opening portion formed in a side surface thereof.

### Effect

According to the electronic musical instrument described in claim 1, because a packing box formed into a box shape capable of accommodating the converter and the output device is included and the packing box has an opening portion formed in a side surface thereof, it is possible to use the packing box as a percussion instrument simulating a Cajon taking the opening portion as a sound hole. That is, because it is possible to use the electronic musical instrument employing the packing box simulating a Cajon, the labor of preparing a musical instrument can be saved. Accordingly, there is an effect that the electronic musical instrument is easy to use.

According to the electronic musical instrument described in claim 2, the following effects are achieved in addition to the effect exhibited by the electronic musical instrument described in claim 1. Because a cushioning material formed into a shape corresponding to internal dimensions of the packing box and configured to be capable of being inserted into the packing box is included, rigidity of the packing box can be increased by inserting the cushioning material (in which the converter and the output device are taken out) into the packing box.

In this case, the cushioning material has an accommodating portion formed as a space capable of accommodating the converter and the output device, and a communication hole making the accommodating portion communicate with the outside of the cushioning material and formed in a side surface of the cushioning material. Accordingly, when the cushioning material with the converter and the output device taken out of the accommodating portion is inserted into the packing box to be used as a percussion instrument, the accommodating portion and the opening portion communicate with each other through the communication hole by inserting the cushioning material with the communication hole facing the opening portion.

That is, because a space (accommodating portion) that communicates with the outside of the packing box through the opening portion even when the cushioning material is inserted into the packing box is formed in the packing box, a percussion instrument simulating a Cajon can be constituted by the cushioning material and the packing box. Accordingly, there is an effect that durability of the packing box against beating can be improved by the cushioning material and a beating sound similar to a Cajon can be generated by beating the packing box.

According to the electronic musical instrument described in claim 3, the following effects are achieved in addition to the effect exhibited by the electronic musical instrument described in claim 2. The cushioning material with the converter and the output device accommodated in the accommodating portion is inserted into the packing box with a posture that a side surface without the communication hole is directed toward the opening portion, and thereby the opening portion is blocked by the side surface without the communication hole of the cushioning material in a packing state that the converter, the output device, and the cushioning material are packed in the packing box. Accordingly, there is an effect that because it is possible to prevent the opening portion from being opened in the packing state, foreign substances can be suppressed from entering the inside through the opening portion and aesthetic design of the electronic musical instrument in the packing state can be improved.

According to the electronic musical instrument described in claim 4, in addition to the effect exhibited by the electronic musical instrument describe in claim 3, because the side surface with the opening portion of the packing box and the side surface of the cushioning material blocking the opening portion in the packing state are set to have the same color, a sense of discomfort when the opening portion of the packing box is blocked by a side surface of the cushioning material can be suppressed. That is, there is an effect that compared with a case in which the side surface of the packing box and the side surface of the cushioning material are set to have different colors, the opening portion can be less conspicuous in the packing state, and thus the aesthetic design of the electronic musical instrument in the packing state is improved.

According to the electronic musical instrument described in claim 5, the following effects are achieved in addition to the effect exhibited by the electronic musical instrument described in any one of claims 2 to 4. The cushioning material has a supporting surface that supports the converter and the output device accommodated in the accommodating portion, and a void space is formed between an inner surface of the packing box and the supporting surface in the state that the cushioning material is inserted into the packing box. The void space has a function of absorbing shock to the converter and the output device in the packing state and a function of resonating vibration of the packing box when the cushioning material and the packing box are used as a percussion instrument. That is, there is an effect that damage to the converter and the output device due to shock from outside in the packing state can be prevented and a beating sound similar to a Cajon can be generated by beating the packing box.

According to the electronic musical instrument described in claim 6, in addition to the effect exhibited by the electronic musical instrument described in any one of claims 2 to 5, because the packing box and the cushioning material are respectively made of a cardboard and a paper thickness of the packing box is smaller than a paper thickness of the cushioning material, when a percussion instrument is configured by inserting the cushioning material into the packing box, rigidity of the packing box can be increased by the cushioning material and the packing box can be easily vibrated when beating the packing box.

That is, by inserting the cushioning material, the rigidity of the packing box and the cushioning material as a whole is increased, and the rigidity for protecting the converter and the output device in the packing state can be secured. Accordingly, the thickness of the packing box can be reduced correspondingly, and thus the packing box itself is easily vibrated by beating. Therefore, there is an effect that vibration can be easily detected by the converter mounted in the packing box.

According to the electronic musical instrument described in claim 7, in addition to the effect exhibited by the electronic musical instrument described in claim 6, because the packing box includes a blocking portion formed into substantially the same shape as the opening portion and connected to the opening portion to block the opening portion and the connection portion of the opening portion and the blocking portion is formed into a perforation shape, the opening portion can be blocked by the blocking portion in the packing state. Further, when the packing box is used as a percussion instrument, the opening portion can be easily formed by removing the blocking portion along the perforation. Therefore, there is an effect in that foreign substances can be suppressed from entering the opening portion in the packing state and the packing box simulating a Cajon can be easily formed.

According to the electronic musical instrument described in claim 8, in addition to the effect exhibited by the electronic musical instrument described in claim 6 or 7, because an opening area of the opening portion is set to 2% to 10% of an area of the side surface with the opening portion of the packing box, the opening area of the opening portion can be secured and deterioration of the rigidity of the packing box can be suppressed. That is, a flow path for air flowing through the opening portion when beating the packing box can be secured, and the rigidity of the packing box can be secured. Therefore, there is an effect that a beating sound similar to a Cajon can be generated by beating the packing box and the durability of the packing box against beating can be improved.

According to the electronic musical instrument described in claim 9, in addition to the effect exhibited by the electronic musical instrument described in any one of claims 6 to 8, the packing box includes a cover portion blocking a side surface of the packing box in an up-down direction and formed as an insertion-type cover, and an assembling-type bottom blocking the other side surface opposite to the cover portion in the up-down direction of the packing box and formed as an assembling-type bottom, and characters or decoration is drawn on a side surface of the packing box and the cover portion is positioned over the characters or the decoration in a height direction. Accordingly, a user can be urged to use the electronic musical instrument in a state that the cover portion side of the packing box is directed upward.

That is, when the packing box is used as a percussion instrument, the user can beat the side surface of the packing box on an insertion-type cover side that does not deform easily in comparison with the assembling-type bottom, and thus there is an effect in that durability of the packing box against beating is improved.

According to the electronic musical instrument described in claim 10, in addition to the effect exhibited by the electronic musical instrument described in claim 9, because the characters or the decoration is drawn on the side surface opposite to the side surface with the opening portion among the side surfaces of the packing box, the user can be urged to use the electronic musical instrument with the cover portion side of the packing box directed upward. That is, because the surface opposite to the side surface having a sound hole is usually set as the top head in a Cajon, the user can be made to easily recognize the decoration or the characters by drawing the decoration or the characters on the side surface (top head) of the packing box opposite to the side surface having the opening portion (corresponding to the sound hole). Accordingly, there is an effect that the user can reliably beat the side surface of the packing box on the cover side.

According to the electronic musical instrument described in claim 11, in addition to the effect exhibited by the electronic musical instrument described in claim 9 or 10, because ridges of corrugating cores forming surfaces of the packing box and the cushioning material along an up-down direction extend in the up-down direction of the packing box and the cushioning material, the rigidity of the packing box against a load in the up-down direction can be increased. Accordingly, even if a load is applied to the packing box from above, damage to the packing box can be suppressed. Therefore, there is an effect that the durability of the packing box as a percussion instrument can be improved.

According to the electronic musical instrument described in claim 12, in addition to the effect exhibited by the electronic musical instrument described in any one of claims 9 to 11, because the packing box is formed into a rectangular parallelepiped shape and the opening portion is formed at a left-right center of the side surface with the opening portion of the packing box when the side surface is seen from the front, the packing box can be formed into a shape more similar to a Cajon. Accordingly, there is an effect in that a beating sound similar to a Cajon can be generated by beating the packing box.

According to the electronic musical instrument described in claim 13, in addition to the effect exhibited by the electronic musical instrument described in any one of claims 1 to 12, because the opening portion is formed into a circular shape, the packing box can be formed into a shape more similar to a Cajon. Accordingly, there is an effect that a beating sound similar to a Cajon can be generated by beating the packing box and the aesthetic design of the packing box can be improved.

### BRIEF DESCRIPTION OF THE DRAWINGS

FIG. 1(a) is a perspective view of an electronic musical instrument in a packing state in an embodiment of the present invention, and FIG. 1(b) is a perspective view of the electronic musical instrument which shows the state when the packing box is open from the state of FIG. 1(a).

FIG. 2(a) is a perspective view of the packing box, and FIG. 2(b) is a perspective view of a cushioning material, a converter, and an output device which shows the state when the converter and the output device have been taken out of the cushioning material.

FIG. 3(a) is a front view of the packing box, and FIG. 3(b) is a developed view of the packing box.

FIG. 4(a) is a front view of the cushioning material, FIG. 4(b) is a cross-sectional view of the cushioning material along a line IVb-IVb of FIG. 4(a), and FIG. 4(c) is a cross-sectional view of the cushioning material along a line IVc-IVc of FIG. 4(a).

FIG. 5 is a developed view of the cushioning material.

FIG. 6(a) is an exploded perspective view of the packing box and the cushioning material that constitute a percussion instrument, and FIG. 6(b) is a perspective view of an electronic musical instrument which shows the state when the packing box and the cushioning material are used as a percussion instrument.

FIG. 7(a) is a perspective view of an electronic musical instrument which shows the state before packing, and FIG. 7(b) is a perspective view of an electronic musical instrument in a packing state.

### DESCRIPTION OF THE EMBODIMENTS

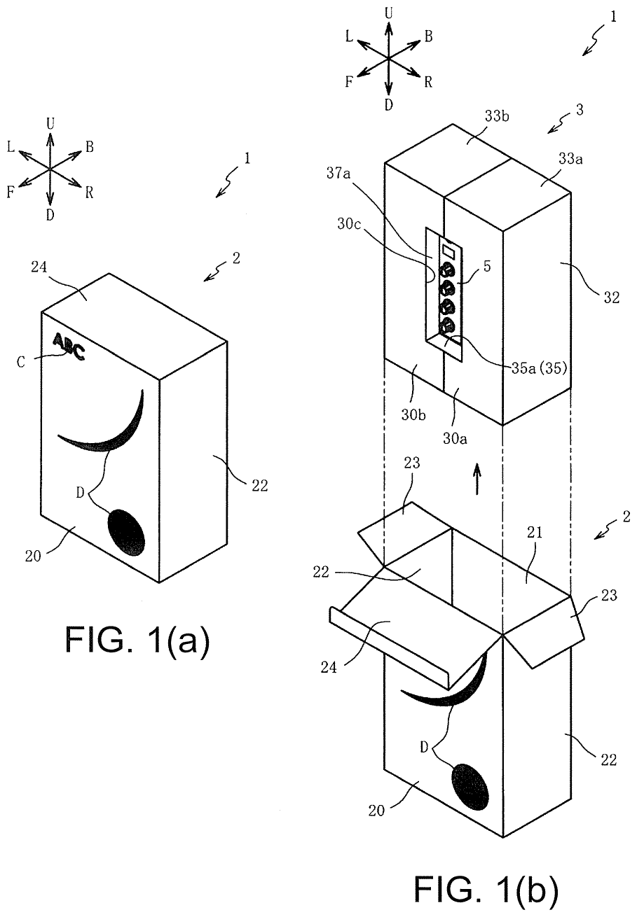

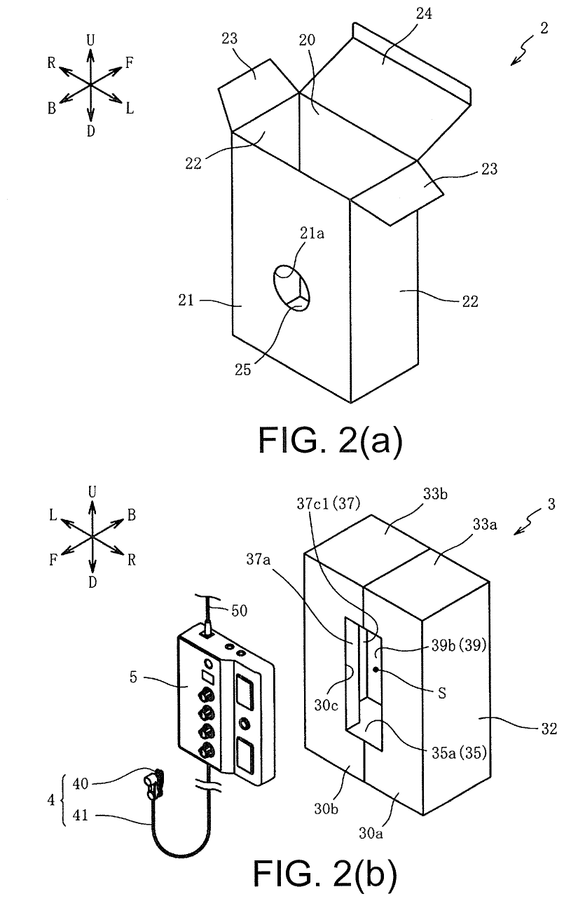

Preferred embodiments of the present invention are described below with reference to the accompanying drawings. First, the overall configuration of an electronic musical instrument 1 is described with reference to FIG. 1(a) to FIG. 2(b).

FIG. 1(a) is a perspective view of the electronic musical instrument 1 in a packing state in an embodiment of the present invention, and FIG. 1(b) is a perspective view of the electronic musical instrument 1 which shows the state when a packing box 2 is open from the state of FIG. 1(a). FIG. 2(a) is a perspective view of the packing box 2, and FIG. 2(b) is a perspective view of a cushioning material 3, a converter 4, and an output device 5 which shows the state when the converter 4 and the output device 5 have been taken out of the cushioning material 3.

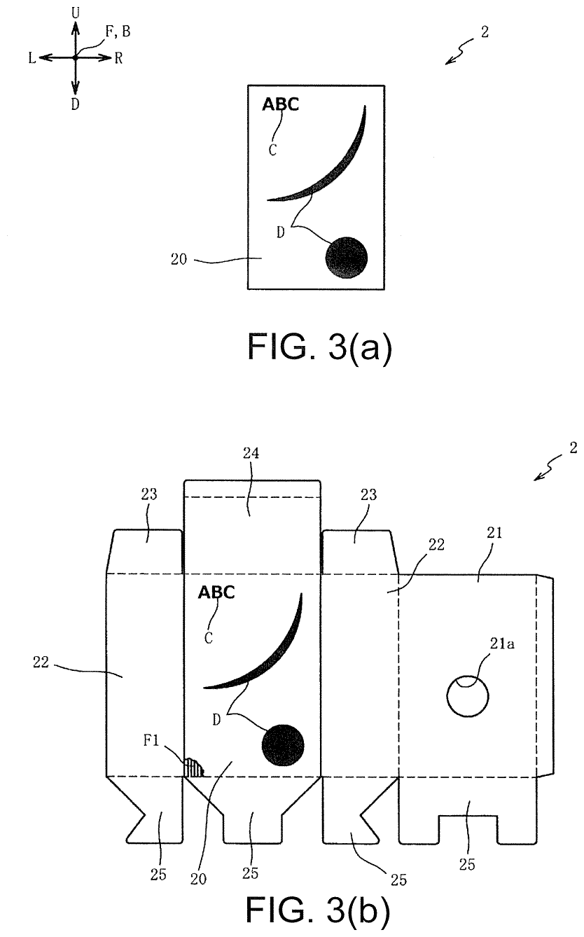

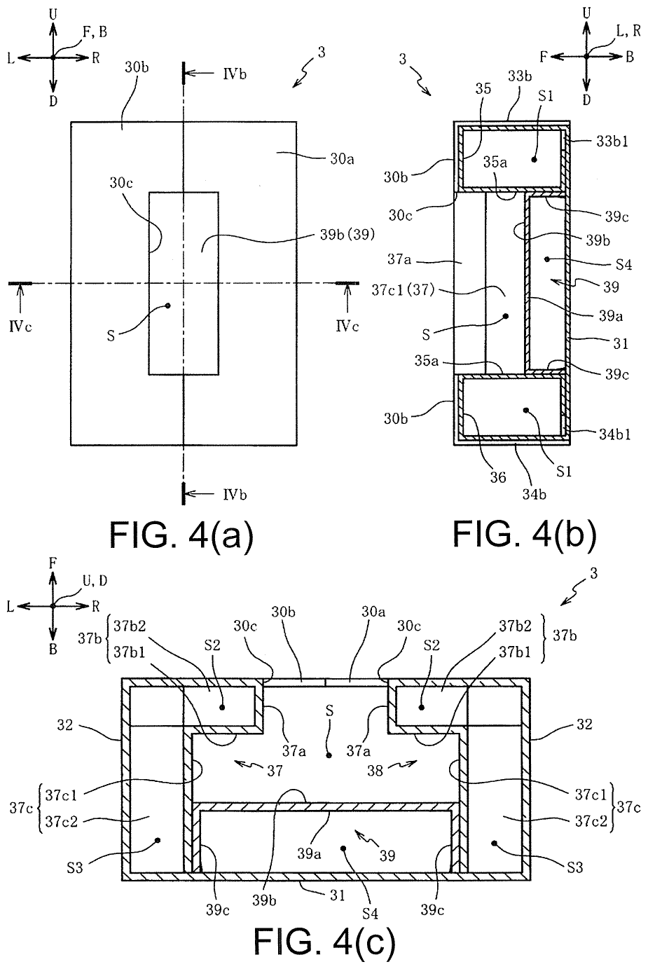

In the drawings, the arrow U-D, the arrow L-R, and the arrow F-B of FIG. 1(a) to FIG. 2(b) indicate the up-down direction, the width direction, and the front-back direction of the packing box 2 and the cushioning material 3, and the same applies to FIG. 3(a) to FIG. 4(c). Further, the “packing state” is defined as a state when the cushioning material 3 accommodating the converter 4 and the output device 5 is inserted (received) in the packing box 2.

As shown in FIG. 1(a) to FIG. 2(b), the electronic musical instrument 1 includes the packing box 2 formed into a rectangular parallelepiped box, a cushioning material 3 configured to be capable of being inserted into the packing box 2, and a converter 4 and an output device 5 (see FIG. 2(a) and FIG. 2(b)) packed in the backing box 2 in a state of being covered by the cushioning material 3.

The packing box 2 is a cardboard box for packing the converter 4 and the output device 5, and the cushioning material 3 is a cushioning material for absorbing the shock that is applied to the converter 4 and the output device 5 in a packing state.

The converter 4 is configured as a contact microphone that includes a clip 40 for mounting the converter 4 on a vibrator, a sensor unit (not shown) disposed on the clip 40 and used to detect vibration of the vibrator and convert the vibration into an electrical signal, and a cable 41 having one end connected to the clip 40 and the other end connected to the output device 5.

The clip 40 is configured as a clip for holding the edge of a sound hole of a musical instrument (e.g., a guitar or a Cajon) or other plate-shaped bodies (e.g., a plate, a magazine, etc.). Accordingly, for example, by mounting the converter 4 on the edge of a sound hole of a Cajon through the clip 40, vibration when the Cajon is beaten is converted into an electrical signal by the converter 4, and the electrical signal is output to the output device 5 through the cable 41.

The output device 5 is an effector (effecting device) for applying an effect to the electrical signal (musical sound signal) input from the converter 4 to change the tone color of the musical sound, and includes an output cable 50 for outputting the musical sound signal to the outside (e.g., an amplifier and a speaker). Accordingly, for example, by connecting the output cable 50 to an amplifier and a speaker, musical sound based on the musical sound signal is output from the speaker.

The packing box 2 has a first side plate 20 (see FIG. 1(a)) forming the side surface of the front side, a second side plate 21 (see FIG. 2(a)) forming the side surface of the rear side opposite to the first side plate 20, a pair of third side plates 22 connecting both end portions of the first side plate 20 and the second side plate 21 in a width direction and forming side surfaces of the packing box 2 in the width direction, a pair of inner flaps 23 connected to upper ends of the pair of third side plates 22, a cover 24 forming the top surface of the packing box 2 together with the pair of inner flaps 23, and bottom flaps 25 forming the bottom surface opposite to the cover 24.

Characters C or decoration D is drawn on the surface of the first side plate 20 (see FIG. 1(a)) and an opening portion 21a is formed in the second side plate 21 (see FIG. 2(a)). The opening portion 21a is a portion formed as a sound hole of the packing box 2, and by forming the opening portion 21a, the packing box 2 can be used as a percussion instrument simulating a Cajon.

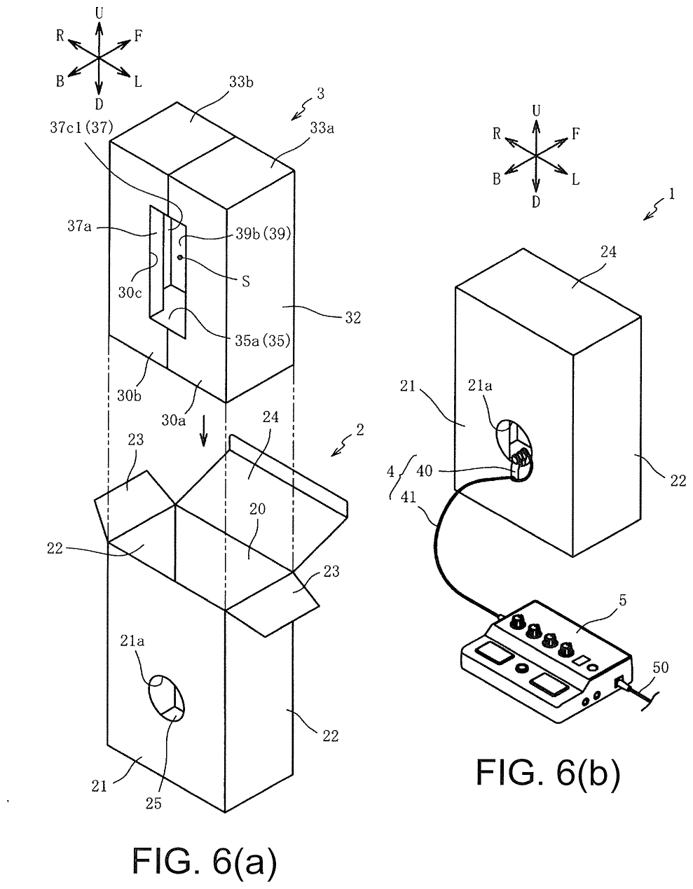

The opening area of the opening portion 21a is set to 2% to 10% of the area of the second side plate 21. Further, the diameter of the opening portion 21a is set as a dimension through which the clip 40 of the converter 4 can be inserted, and thus the converter 4 can be mounted in the opening portion 21a by the clip 40 (see FIG. 6(b)).

Accordingly, when the packing box 2 is beaten in a state that the converter 4 is mounted in the opening portion 21a (sound hole), vibration by the beating is converted into an electrical signal by the converter 4, and the electrical signal is output to the outside through the output device 5. That is, because it is possible to employ the packing box 2 simulating a Cajon to use the electronic musical instrument 1, the labor of preparing a musical instrument is saved. Accordingly, the electronic musical instrument 1 is easy to use. In addition, for example, even a user without a musical instrument (e.g., a guitar or a Cajon) can employ the packing box 2 to use the electronic musical instrument 1, and thus the versatility of the electronic musical instrument 1 is improved.

In this configuration, when the opening area of the opening portion 21a in which the converter 4 is mounted is excessively small (e.g., less than 2% of the area of the second side plate 21), the flow path for the air flowing through the opening portion 21a narrows, and it is difficult to generate a beating sound similar to a Cajon when beating the packing box 2. In addition, when the opening area of the opening portion 21a is excessively large (e.g., larger than 10% of the area of the second side plate 21), rigidity of the packing box 2 decreases, and thus durability of the packing box 2 against beating is deteriorated.

However, according to the electronic musical instrument 1 of the present embodiment, because the opening area of the opening portion 21a is set to 2% to 10% of the area of the second side plate 21, a flow path for the air flowing through the opening portion 21a when beating the packing box 2 can be secured, and the rigidity of the packing box 2 can be secured. Accordingly, a beating sound similar to a Cajon can be generated when beating the packing box 2 and the rigidity of the packing box 2 can be secured to improve the durability of the packing box 2 against beating.

In addition, in a front view showing the second side plate 21 from the front (i.e., a rear view of the packing box 2), the opening portion 21a is positioned at the center in the left-right direction of the second side plate 21 (i.e., in the width direction of the packing box 2). Accordingly, the packing box 2 can be formed into a shape more similar to a Cajon, and thus a beating sound similar to a Cajon can be generated by beating the packing box 2.

In addition, because the opening portion 21a is formed as a circular opening, the packing box 2 can be formed into a shape more similar to a Cajon. Accordingly, a beating sound more similar to a Cajon can be generated by beating the packing box 2 and aesthetic design of the packing box 2 can be improved.

Here, the detailed configuration of the packing box 2 is described with reference to FIG. 3(a) and FIG. 3(b). FIG. 3(a) is a front view of the packing box 2 and FIG. 3(b) is a developed view of the packing box 2.

As shown in FIG. 3(a) and FIG. 3(b), the cover 24 is connected to the upper end of the first side plate 20, and the upper portion of the packing box 2 is configured as an insertion-type cover portion by the cover 24 and the inner flaps 23. The cover 24 is formed over the characters C and the decoration D in the height direction (the height direction of the characters C and the decoration D, the up-down direction in FIG. 2(a) and FIG. 2(b)). That is, when the packing box 2 is placed with the cover 24 directed vertically upward, the vertical direction of the packing box 2 and the vertical directions of the characters C and the decoration D are substantially accorded (the characters C and the decoration D are upright).

The bottom flaps 25 are respectively connected to the lower ends of the first side plate 20, the second side plate 21, and the pair of third side plates 22 of the packing box 2 (the lower end portions in FIG. 3(b)). The bottom flaps 25 are configured as an assembling-type bottom being assembled by folding the bottom flaps into each other (a wedging bottom).

Here, the bottom flaps 25 configured as an assembling-type bottom are easy to deform under a load from a side (e.g., in the front-rear direction or left-right direction of the packing box 2) in comparison with the cover 24 configured as an insertion-type cover (and the inner flaps 23). In this case, when a Cajon is played, a side surface on the upper end side (upper side in the vertical direction) of the Cajon placed on the floor is usually the top head, and similarly, it is assumed that in the packing box 2 simulating a Cajon, the side surface on the upper end side is beaten as a top head in a state that the packing box 2 is placed on the floor. Accordingly, for example, when the first side plate 20 or the second side plate 21 of the packing box 2 on the bottom surface side (the bottom flaps 25 side) configured from assembling-type bottoms is beaten, the packing box 2 is easily damaged.

However, according to the electronic musical instrument 1 of the present embodiment, because the cover 24 is disposed over the characters C and the decoration D in the height direction (the height direction of the characters C and the decoration D), the user may be urged to use the packing box 2 with the cover 24 directed upward. That is, by using the packing box 2 as a percussion instrument with the cover 24 directed vertically upward, the user can be made to beat the side surface (e.g., the first side plate 20 or the second side plate 21) on the side of the insertion-type cover 24 that does not easily deform in comparison with the assembling-type bottoms, and thus the durability of the packing box 2 against beating is improved.

In addition, because a Cajon is usually played using the surface (surface on an opposite side) opposite to the surface having a sound hole as the top head, similarly, it is assumed that in the packing box 2, the first side plate 20 opposite to the second side plate 21 (facing the second side plate 21) having the opening portion 21a is beaten as the top head.

However, according to the electronic musical instrument 1 of the present embodiment, because the characters C or the decoration D is drawn on the first side plate 20 opposite to the second side plate 21 having the opening portion 21a, the characters C or the decoration D can be easily recognized by the user. Accordingly, the user is urged to use the packing box 2 with the cover 24 directed upward, and the first side plate 20 on the cover 24 side can be reliably beaten by the user.

Further, in the present embodiment, because the opening portion 21a is formed under the center in the up-down direction of the packing box 2, the area of the region over the opening portion 21a (on the cover 24 side) is larger than the area of the region under the opening portion 21a (the bottom flaps 25 side). Accordingly, even if the user uses the second side plate 21 as the top head, the side surface on the cover 24 side can be reliably beaten by the user, and thus the durability of the packing box 2 against beating is improved.

Further, when the packing box 2 is used in a state of being placed on the floor the same as a Cajon, for example, a load applied from the user easily acts from the top of the packing box 2. However, according to the electronic musical instrument 1 of the present embodiment, the ridges of corrugating cores F1 of the first side plate 20, the second side plate 21, and the third side plates 22 (portions forming the up-down surfaces of the packing box 2) extend in the up-down direction of the packing box 2, and thus the rigidity of the packing box 2 against an load applied in the up-down direction can be increased. Accordingly, even if a load is applied to the packing box 2 from above, damage to the packing box 2 can be suppressed. Therefore, the durability of the packing box 2 as a percussion instrument can be improved.

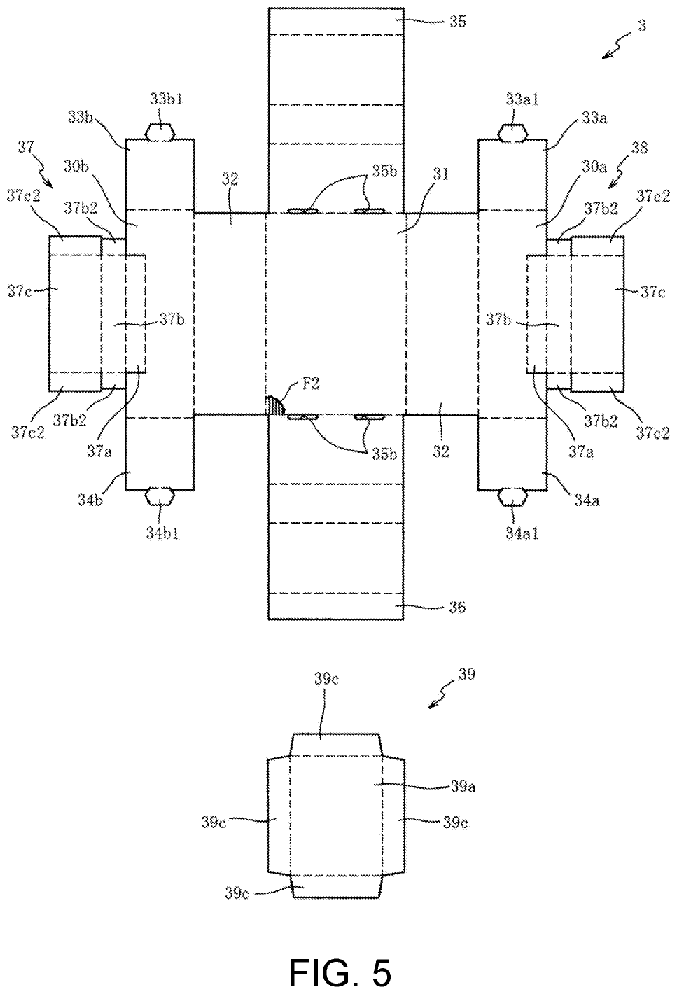

Next, the detailed configuration of the cushioning material 3 is described with reference to FIG. 4(a) to FIG. 5. FIG. 4(a) is a front view of the cushioning material 3, FIG. 4(b) is a cross-sectional view of the cushioning material 3 along a line IVb-IVb of FIG. 4(a), and FIG. 4(c) is a cross-sectional view of the cushioning material 3 along a line IVc-IVc of FIG. 4(a). FIG. 5 is a developed view of the cushioning material 3. Besides, in FIG. 4(c), the cross-section of the cushioning material 3 is enlarged for easy understanding.

As shown in FIG. 4(a) to FIG. 5, the cushioning material 3 is formed as a rectangular parallelepiped box having external dimensions corresponding to the internal dimensions of the packing box 2, and an accommodating portion S capable of accommodating the converter 4 and the output device 5 is formed inside the cushioning material 3. The cushioning material 3 is made of a cardboard having the same color as the packing box 2 and the thickness of paper is larger than the thickness of paper of the packing box 2.

The cushioning material 3 mainly has first plates 30a and 30b (see FIG. 4(a) to FIG. 4(c)) forming the side surface on the front side, a second plate 31 forming the side surface on the rear side of the cushioning material 3, a pair of third plates 32 forming side surfaces in the width direction of the cushioning material 3, fourth plates 33a and 33b forming the top surface of the cushioning material 3, and fifth plates 34a and 34b forming the bottom surface of the cushioning material 3.

The first plate 30a and the first plate 30b are formed in pairs at the left and right taking the center of the cushioning material 3 in the width direction as a boundary and are connected to the second plate 31 via the pair of third plates 32, respectively. The fourth plate 33a and the fourth plate 33b are formed in pairs at the left and right taking the center of the cushioning material 3 in the width direction as a boundary (see FIG. 6(a)) and are connected to the first plate 30a and the first plate 30b, respectively.

The fourth plates 33a and 33b extend from the first plates 30a and 30b along the top surface of an upper supporting portion 35 toward the second plate 31 (see FIG. 4(b)) and are fixed by inserting insertion portions 33a1 and 33b1 formed at extension ends of the fourth plates 33a and 33b into through-holes 35b formed at the upper supporting portion 35 (see FIG. 5).

The fifth plates 34a and 34b are formed symmetrically to the fourth plates 33a and 33b with the accommodating portion S therebetween in the up-down direction of the cushioning material 3 and are fixed by inserting insertion portions 34a1 and 34b1 formed on the fifth plates 34a and 34b into through-holes 35b of a lower supporting portion 36 (see FIG. 5).

Accordingly, the cushioning material 3 can be disassembled by pulling the insertion portions 33a1 and 33b1 and the insertion portions 34a1 and 34b1 from the through-holes 35b.

Further, the cushioning material 3 has the upper supporting portion 35 and the lower supporting portion 36 respectively connected to both end portions in the up-down direction of the second plate 31 (upper and lower end portions in FIG. 4(b)), a left supporting portion 37 and a right supporting portion 38 respectively connected to both end portions in the width direction of a communication hole 30c (left and right end portions in FIG. 4(c)), and a central supporting portion 39 disposed in the region surrounded by the upper supporting portion 35, the lower supporting portion 36, the left supporting portion 37, and the right supporting portion 38.

Besides, the upper supporting portion 35 and the lower supporting portion 36 are symmetrically formed up and down (with the accommodating portion S therebetween) in the up-down direction of the cushioning material 3, and the left supporting portion 37 and the right supporting portion 38 are also symmetrically formed left and right (with the accommodating portion S therebetween) in the width direction of the cushioning material 3. Accordingly, in the description below, the upper supporting portion 35 and the left supporting portion 37 are described, and the lower supporting portion 36 and the right supporting portion 38 are given the same reference numerals and the description is omitted.

The upper supporting portion 35 is formed in a tubular shape having a rectangular vertical cross section by folding back four times a rectangular plate body connected to the upper end of the second plate 31 and having a rectangular shape in a front view, including the part connected with the upper end of the second plate 31, and a void space S1 is formed inside the upper supporting portion 35. The surface of the upper supporting portion 35 at the center (at the lower side in FIG. 4(b)) in the up-down direction of the cushioning material 3 is configured as a supporting surface 35a for supporting the converter 4 and the output device 5. In addition, the through-holes 35a are formed at end portions on the second plate 31 side of the upper supporting portion 35.

The left supporting portion 37 has a communication plate 37a (see FIG. 4(c)) connected to end portion of the communication hole 30c in the width direction and extending toward the second plate 31, a first supporting plate 37b extending outward in the width direction (to the left in FIG. 4(c)) from the extension end of the communication plate 37a, and a second supporting plate 37c extending from the extension end of the first supporting plate 37b toward the second plate 31.

The communication plate 37a is a part for communicating the communication hole 30c with the accommodating portion S. The first supporting plate 37b has a supporting surface 37b1 formed on the rear side (lower side in FIG. 4(c)) and used to support the converter 4 and the output device 5, and leg portions 37b2 connected to both ends in the up-down direction of the first supporting plate 37b.

The leg portions 37b2 extend from the first supporting plate 37b toward the first plate 30b (see FIG. 4(c)) and the extension end thereof comes into contact with the inner surface of the first plate 30b. Accordingly, a void space S2 is formed between the inner surface of the first plate 30b and the supporting surface 37b1.

The second supporting plate 37c includes a supporting surface 37c1 formed on the inner side in the width direction (right side in FIG. 4(c)) and used to support the converter 4 and the output device 5, and leg portions 37c2 connected to both ends in the up-down direction of the second supporting plate 37c.

The leg portions 37c2 extend outward in the width direction from the second supporting plate 37c and the extension end thereof comes into contact with the inner surface of the third plate 32. Accordingly, a void space S3 is formed between the inner surface of the third plate 32 and the supporting surface 37c1.

The central supporting portion 39 has a supporting portion 39a formed into a plate shape being rectangular in a front view, a supporting surface 39b formed as the surface on the front side (upper side in FIG. 4(c)) of the leg portion 39a and used to support the converter 4 and the output device 5, and plate-shaped leg portions 39c extending from four edges of the supporting portion 39a toward the second plate 31 and having extension ends coming into contact with the second plate 31. Accordingly, a void space S4 is formed between the inner surface of the second plate 31 and the supporting surface 39b. By forming the void spaces S1-S4, the shock that is applied to the converter 4 and the output device 5 in the packing state can be cushioned.

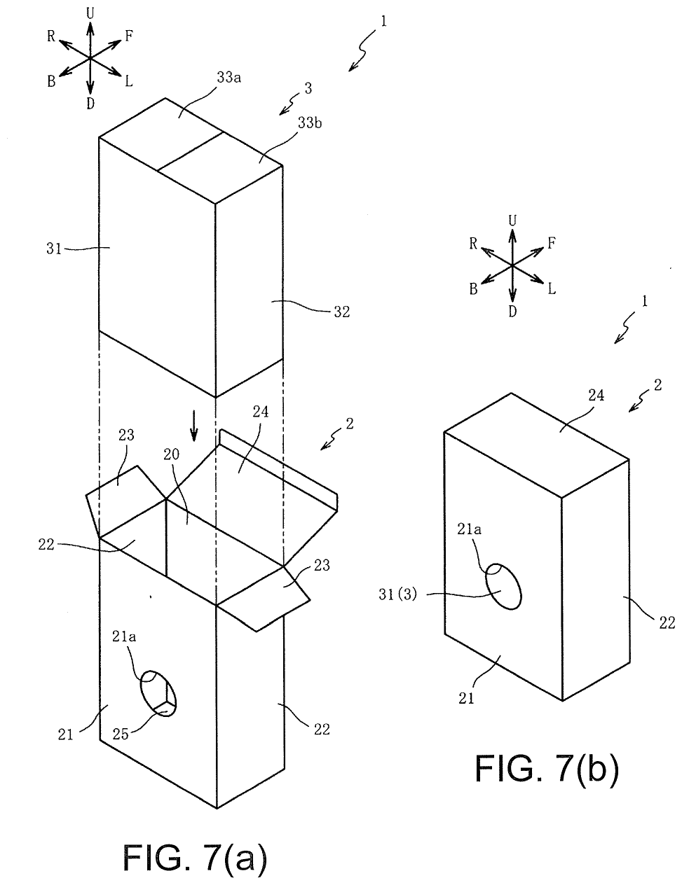

Next, a method of using the electronic musical instrument 1 is described with reference to FIG. 6(a) and FIG. 6(b). FIG. 6(a) is an exploded perspective view of the packing box 2 and the cushioning material 3 constituting a percussion instrument, and FIG. 6(b) is a perspective view of the electronic musical instrument 1 which shows the state when the packing box 2 and the cushioning material 3 are used as a percussion instrument. Besides, the arrow U-D, the arrow L-R, and the arrow F-B of FIG. 6(a) and FIG. 6(b) indicate the up-down direction, the width direction, and the front-rear direction of the packing box 2 and the same applies to FIG. 7(a) and FIG. 7(b). In FIG. 6(b), the cross-section of the reference numeral of the cushioning material 3 is omitted for easy understanding.

As shown in FIG. 6(a) and FIG. 6(b), when the electronic musical instrument 1 is used, the user dissembles the cushioning material 3, takes out the converter 4 and the output device 5 from the accommodating portion S, and then assembles the cushioning material 3 back. The assembled cushioning material 3 (with the converter 4 and the output device 5 taken out) is inserted into the packing box 2 in a posture that the communication hole 30c is directed toward the opening portion 21a (see FIG. 6(a)).

In this case, the opening dimension in the width direction of the communication hole 30c is set slightly larger than the diameter of the opening portion 21a and the opening dimension in the up-down direction is set larger than the diameter of the opening portion 21a. In addition, when the cushioning material 3 is inserted into the packing box 2 in a posture that the communication hole 30c is directed toward the opening portion 21a, the communication hole 30c is formed at the position where the entire opening portion 21a overlaps the communication hole 30c (the communication hole 30c is formed at a position corresponding to the opening portion 21a) in the front view of the packing box 2.

Accordingly, by inserting the cushioning material 3 into the packing box 2 in a posture that the communication hole 30c is directed toward the opening portion 21a, the accommodating portion S and the opening portion 21a communicate with each other through the communication hole 30c (see FIG. 4(b)). Accordingly, the converter 4 can be mounted on the edge of the opening portion 21a by the clip 40 in the state that the cushioning material 3 is inserted into the packing box 2.

Accordingly, for example, compared with a case that a percussion instrument simulating a Cajon is constituted only by the packing box 2, the rigidity of the packing box 2 can be increased by inserting the cushioning material 3. Therefore, the durability of the packing box 2 against beating can be improved.

In addition, by communicating the accommodating portion S with the opening portion 21a through the communication hole 30c, a space (the accommodating portion S) through the opening portion 21a is formed in the packing box 2 even in a state that the cushioning material 3 is inserted into the packing box 2, and thus vibration caused by beating the packing box 2 can be resonated in the accommodating portion S. In addition, similarly, the vibration caused by beating the packing box 2 can also be resonated in the void spaces S1-S4 formed in the cushioning material 3. Accordingly, even when the cushioning material 3 is inserted into the packing box 2, a beating sound similar to a Cajon can be generated by the packing box 2 and the cushioning material 3.

Here, by inserting the cushioning material 3 into the packing box 2, the rigidity of the cushioning material 3 and the packing box 2 as a whole is increased, and the rigidity for protecting the converter 4 and the output device 5 in the packing state can be secured. Accordingly, the thickness of the packing box 2 can be reduced correspondingly.

That is, by making the cushioning material 3 bear the rigidity of the packing box 2 and the cushioning material 3 as a whole and making the thickness of the packing box 2 that is actually beaten smaller than the thickness of the cushioning material 3, the rigidity of the packing box 2 and the cushioning material 3 as a whole can be ensured and the packing box 2 can be easily vibrated through beating. Therefore, the vibration can be easily detected by the converter 4 mounted in the packing box 2, and thus musical sound of the beating against the packing box 2 can be generated with high precision.

Here, for example, when the opening portion 21a is formed at a position deviating from the center of the second side plate 21 in the width direction of the packing box 2, in order to make the opening portion 21a communicate with the communication hole 30c of the cushioning material 3, it is required to form the communication hole 30c of the cushioning material 3 at a position deviating from the center in the width direction or increase the opening dimension of the communication hole 30c. In this case, for example, when the communication hole 30c of the cushioning material 3 is formed at a position deviating from the center in the width direction, it is required to form the cushioning material 3 asymmetrically left and right in the front view, and the manufacturing cost of the cushioning material 3 is increased. In addition, when the opening dimension in the width direction of the communication hole 30c is increased, the rigidity of the cushioning material 3 is correspondingly decreased.

However, according to the electronic musical instrument 1 of the present embodiment, because the opening portion 21a is formed at the center of the second side plate 21 in the width direction of the packing box 2, the opening dimension in the width direction of the communication hole 30c can be reduced as much as possible and the cushioning material 3 can be formed to be left-right symmetrical in the front view. Accordingly, the rigidity of the cushioning material 3 can be secured and the manufacturing cost of the cushioning material 3 can be reduced.

In addition, when the cushioning material 3 is inserted into the packing box 2, the ridges of the corrugating cores F2 of the cushioning material 3 (portions forming the surfaces along the up-down direction of the cushioning material 3 such as the first plates 30a and 30b, the second plate 31, and the third plate 32) extend in the up-down direction of the packing box 2, the rigidity of the packing box against a load applied from above can be further increased compared with a case when a percussion instrument is constituted only by the packing box 2. Accordingly, even if a load is applied to the packing box 2 from above, damage to the packing box 2 can be suppressed, and thus the durability of the packing box 2 as a percussion instrument is improved.

Next, a method of packing the electronic musical instrument 1 is described with reference to FIG. 7(a) and FIG. 7(b). FIG. 7(a) is a perspective view of the electronic musical instrument 1 which shows the state before backing, and FIG. 7(b) is a perspective view of the electronic musical instrument 1 in a packing state.

As shown in FIG. 7(a) and FIG. 7(b), the second plate 31 of the cushioning material 3 does not have the communication hole 30c and is formed as a separation wall separating the accommodating portion S from the outside of the cushioning material 3 (see FIG. 7(a)). In the packing state, the cushioning material 3 (with the converter 4 and the output device 5 accommodated therein) is inserted into the packing box 2 in a posture that the second plate 31 without the communication hole 30c is directed toward the opening portion 21a.

Accordingly, in the packing state, the outer surface of the second plate 31 is in contact with the inner surface of the first side plate 20, and thereby the opening portion 21a is blocked by the second plate 31 from the inner surface side of the first side plate 20 (see FIG. 7(b)). Accordingly, the opening portion 21 can be prevented from being opened in the packing state, and thus foreign substances can be suppressed from entering the inside through the opening portion 21a and the aesthetic design of the electronic musical instrument 1 in the packing state can be improved.

In this case, because the packing box 2 and the cushioning material 3 are made of cardboards with the same color, the first side plate 20 having the opening portion 21a and the second plate 31 blocking the opening portion 21a are set to have the same color. Accordingly, a sense of discomfort when the opening portion 21a of the packing box 2 is blocked by the second plate 31 of the cushioning material 3 can be suppressed. That is, for example, compared with a case when the first side plate 20 of the packing box 2 and the second plate 31 of the cushioning material 3 are set to have different colors, the opening portion 21a can be prevented from being conspicuous in the packing state, and thus the aesthetic design of the electronic musical instrument 1 in the packing state is improved.

Although the present invention is described above on the basis of embodiments, the present invention is not limited to the embodiments and it may be easily presumed that various modifications and changes are possible without departing from the spirit of the present invention.

For example, in the above embodiment, the case that the packing box 2 is made of a cardboard is described, but the present invention is not limited thereto, and for example, the packing box 2 may be configured by a material made of metal, resin, wood, or paper.

Although the case that the packing box 2 is formed as a rectangular parallelepiped box is described in the above embodiment, the present invention is not limited thereto, and for example, the packing box 2 may be formed into a cylindrical shape or a barrel shape with the side surface of the cylindrical shape partially expanded.

Although the case that the cushioning material 3 is made of a cardboard is described in the above embodiment, the present invention is not limited thereto, and for example, the cushioning material 3 may be made of foamed styrol of synthetic resin or a sponge-like material.

Although the case that the converter 4 is mounted in a vibrator (packing box 2) by the clip 40 is described in the above embodiment, the present invention is not limited thereto, and for example, the converter 4 may be mounted in the vibrator (the packing box 2) by an adhesive tape.

Although an effector (effecting device) is exemplified as the output device 5 in the above embodiment, the present invention is not limited thereto, and for example, the output device 5 may be configured as a sound source device including an amplifier or a speaker.

Although the case that the opening portion 21a is formed into a circular shape is described in the above embodiment, the present invention is not limited thereto, and for example, the opening portion 21a may be formed into a rectangular shape or a polygonal shape.

Although the case that the opening portion 21a is formed in the packing state is described in the above embodiment, the present invention is not limited thereto, and for example, the packing box 2 may be configured to have a blocking portion that blocks the opening portion 21a in the packing state (formed substantially in the same shape as the opening portion 21a). In this case, it is preferable that the blocking portion is connected to the opening portion 21a in a form of closing the opening portion 21a and the connection portion is formed into a perforation shape.

Accordingly, the opening portion 21a can be blocked by the blocking portion in the packing state. In addition, when the packing box 2 is used as a percussion instrument, the opening portion 21a can be easily formed by removing the blocking portion along the perforation. Accordingly, foreign substances can be suppressed from entering through the opening portion 21a in the packing state and the packing box 2 simulating a Cajon can be easily formed.

### REFERENCE SIGNS LIST

1 electronic musical instrument
2 packing box
3 cushioning material
4 converter
5 output device
21a opening portion
23 inner flap (Cover portion)
24 cover (Cover portion)
25 bottom flap (Assembling-type bottom)
30c communication hole
35a, 37b1, 37c1, 39b supporting surface
40 clip
C character
D decoration
F1 corrugating core of packing material
F2 corrugating core of cushioning material
S accommodating part
S1, S2, S3, S4 void space

1. An electronic musical instrument that comprises a converter configured to be freely attached to/detached from a vibrator vibrated by playing of a player and used to convert a vibration detected from the vibrator into an electrical signal, and an output device connected to the converter and used to output the electrical signal converted by the converter to an outside,
wherein the electronic musical instrument comprises a packing box formed into a box shape capable of accommodating the converter and the output device, and
the packing box has an opening portion formed in a side surface thereof.

2. The electronic musical instrument according to claim 1, comprising a cushioning material formed into a shape corresponding to internal dimensions of the packing box and configured to capable of being inserted into the packing box,
wherein the cushioning material has an accommodating portion formed as a space capable of accommodating the converter and the output device, and a communication hole making the accommodating portion communicate with an outside of the cushioning material and formed in a side surface of the cushioning material, and
the cushioning material with the converter and the output device taken out of the accommodating portion is inserted into the packing box in a posture that the communication hole is directed toward the opening portion, and thereby the accommodating portion is communicated with the opening portion through the communication hole.

3. The electronic musical instrument according to claim 2, wherein the cushioning material with the converter and the output device accommodated in the accommodating portion is inserted into the packing box in a postured that a side surface without the communication hole is directed toward the opening portion, and thereby the opening portion is blocked by the side surface without the communication hole of the cushioning material in a packing state that the converter, the output device, and the cushioning material are packed in the packing box.

4. The electronic musical instrument according to claim 3, wherein the side surface with the opening portion of the packing box and the side surface of the cushioning material blocking the opening portion in the packing box are set to have the same color.

5. The electronic musical instrument according to claim 2, wherein the cushioning material comprises a supporting surface that supports the converter and the output device accommodated in the accommodating portion, and
a void space is formed between an inner surface of the cushioning material and the supporting surface in a state that the cushioning material is inserted into the packing box.

6. The electronic musical instrument according to claim 2, wherein the packing box and the cushioning material are respectively made of a cardboard, and
a paper thickness of the packing box is smaller than a paper thickness of the cushioning material.

7. The electronic musical instrument according to claim 6, wherein the packing box has a blocking portion formed into substantially the same shape as the opening portion and connected to the opening portion in a form of blocking the opening portion, and
a connection portion of the opening portion and the blocking portion is formed in a perforation shape.

8. The electronic musical instrument according to claim 6, wherein an opening area of the opening portion is set to 2% to 10% of an area of the side surface of the packing box with the opening portion.

9. The electronic musical instrument according to claim 6, wherein the packing box comprises a cover portion blocking a surface on a side of the packing box in an up-down direction and formed as an insertion-type cover, and an assembling-type bottom portion blocking the other surface of the packing box opposite to the cover portion in the up-down direction and formed as an assembling-type bottom, and
characters or decoration is drawn on a side surface of the packing box, and the cover portion is positioned on an upper side in a height direction of the characters or the decoration.

10. The electronic musical instrument according to claim 9, wherein the characters or the decoration is drawn on a side surface opposite to the side surface with the opening portion among side surfaces of the packing box.

11. The electronic musical instrument according to claim 9, wherein ridges of corrugating cores forming surfaces along an up-down direction of the packing box and the cushioning material extend in the up-down direction of the packing box and the cushioning material.

12. The electronic musical instrument according to claim 9, wherein the packing box is formed into a rectangular parallelepiped shape, and
in a front view of the side surface with the opening portion of the packing box, the opening portion is formed at a center in a left-right direction of the side surface.

13. The electronic musical instrument according to claim 1, wherein the opening portion is formed into a circular shape.

14. An electronic musical instrument that comprises a clip configured to be freely attached to/detached from a vibrator vibrated by playing of a player, a contact microphone disposed on the clip and used to detect a vibration of the vibrator and convert the vibration into a musical sound signal, and an output device connected to the contact microphone and used to output the musical sound signal converted by the contact microphone to an outside.

15. The electronic musical instrument according to claim 14, wherein the output device is an effector that applies an effect to the musical sound signal input from the contact microphone to change a tone color of the musical sound signal.

16. The electronic musical instrument according to claim 14, wherein the output device is a sound source device that outputs the musical sound signal input from the contact microphone.

17. The electronic musical instrument according to claim 14, further comprising a packing box formed into a box shape capable of accommodating the clip, the contact microphone and the output device, wherein the packing box has an opening portion formed in a side surface thereof.

18. The electronic musical instrument according to claim 17, comprising a cushioning material formed into a shape corresponding to internal dimensions of the packing box and configured to capable of being inserted into the packing box,
wherein the cushioning material has an accommodating portion formed as a space capable of accommodating the contact microphone and the output device, and a communication hole making the accommodating portion communicate with an outside of the cushioning material and formed in a side surface of the cushioning material, and
the cushioning material with the contact microphone and the output device taken out of the accommodating portion is inserted into the packing box in a posture that the communication hole is directed toward the opening portion, and thereby the accommodating portion is communicated with the opening portion through the communication hole.

19. The electronic musical instrument according to claim 18, wherein the cushioning material with the contact microphone and the output device accommodated in the accommodating portion is inserted into the packing box in a postured that a side surface without the communication hole is directed toward the opening portion, and thereby the opening portion is blocked by the side surface without the communication hole of the cushioning material in a packing state that the contact microphone, the output device, and the cushioning material are packed in the packing box.

20. The electronic musical instrument according to claim 19, wherein the side surface with the opening portion of the packing box and the side surface of the cushioning material blocking the opening portion in the packing box are set to have the same color.
